(19) United States
(12) Patent Application Publication
(10) Pub. No.: US 2015/0141302 A1
(43) Pub. Date: May 21, 2015

(54) Composition Containing An Emulsified Chelating Agent And Process To Treat A Subterreanean Formation

(71) Applicant: Akzo Nobel Chemicals International B.V., Amersfoort (NL)

(72) Inventors: Hisham Nasr-El-Din, College Station, TX (US); Cornelia Adriana DeWolf, Eerbek (NL); Mohammed Ali Ibrahim Sayed, College Station, TX (US)

(21) Appl. No.: 14/406,421

(22) PCT Filed: Jun. 4, 2013
(86) PCT No.: PCT/EP2013/061472

§ 371 Date: Dec. 8, 2014

Related U.S. Application Data
(60) Provisional application No. 61/661,017, filed on Jun. 18, 2012.

(30) Foreign Application Priority Data
Jul. 5, 2012 (EP) 12175056.6
Apr. 24, 2013 (EP) PCT/EP2013/058457

(51) Int. Cl. C09K 8/74

(52) U.S. Cl. CPC C09K 8/74
USPC 507/241

(57) ABSTRACT

The present invention relates to a composition containing a dispersed phase emulsified in a continuous phase, wherein at least 5 wt % on total weight of the dispersed phase of the composition is a chelating agent selected from the group of glutamic acid N,N-diacetic acid or a salt thereof (GLDA), aspartic acid N,N-diacetic acid or a salt thereof (ASDA), and methylglycine N,N-diacetic acid or a salt thereof (MGDA), and a process for treating a subterranean formation comprising a step of introducing the above composition into the formation.

The present invention relates to a composition containing at least 5 wt % on total weight of a chelating agent selected from the group of glutamic acid N,N-diacetic acid or a salt thereof (GLDA), aspartic acid N,N-diacetic acid or a salt thereof (ASDA), methylglycine N,N-diacetic acid or a salt thereof (MGDA), wherein the chelating agent is emulsified in the composition, and to a process for treating a subterranean formation with this composition.

Subterranean formations from which oil and/or gas can be recovered can contain several solid materials contained in porous or fractured rock formations. The naturally occurring hydrocarbons, such as oil and/or gas, are trapped by overlying rock formations with lower permeability. The reservoirs are found using hydrocarbon exploration methods and often one of the purposes of withdrawing the oil and/or gas there from is to improve the permeability of the formations. The rock formations can be distinguished by their major components and one category is formed by so-called sandstone formations, which contain siliceous materials (like quartz) as the major constituent, while another category is formed by so-called carbonate formations, which contain carbonates (like calcite, chalk, and dolomite) as the major constituent. A third category is formed by shales, which contain very fine particles of many different clays covered with organic materials to which gas and/or oil are adsorbed. Shale amongst others contains many clay minerals like kaolinite, illite, chlorite, and montmorillonite, as well as quartz, feldspars, carbonates, pyrite, organic matter, and cherts.

One process to make formations more permeable is a matrix-acidizing process, wherein an acidic fluid is introduced into the formations trapping the oil and/or gas. Acidic treatment fluids are known in the art and are for example disclosed in several documents that describe acid treatment with HCl. In addition, several documents disclose the use of chelating agents to increase the permeability of the formation. For example, Frenier, W. W., Brady, M., Al-Harthy, S. et al. (2004), “Hot Oil and Gas Wells Can Be Stimulated without Acids,” SPE Production & Facilities 19 (4): 189-199. DOI: 10.2118/86522-PA, show that formulations based on the hydroxyethylaminocarboxylic acid family of chelating agents can be used to increase the production of oil and gas from wells in a variety of different formations, such as carbonate and sandstone formations. M. A. Mahmoud et al. disclose in “Evaluation of a New Environmentally Friendly Chelating Agent for High-Temperature Applications,” presented at the Formation Damage Control SPE Symposium in Lafayette, La. USA, Feb. 10-12, 2010, and later published as SPE 127923, that glutamic acid diacetic acid can be used to matrix-acidize a carbonate formation.

However, in a number of instances a subterranean formation is damaged during treatment with an acidic solution as the acid reacts before reaching the target zone of the treatment, because the reaction rate with the formation is too high. In such cases so-called wash-out takes place, which basically means that the acid reacts fully with the surface of the formation directly adjacent to the wellbore and does not create a path for itself inside the formation.

Also at increased temperatures, such as temperatures above 200° F., often found downhole, there is a need to add more corrosion inhibitor and corrosion inhibitor intensifier, which significantly increases the cost of the treatment. Chelating agents are one of the alternatives for regular HCl that can reduce the reaction rate and spending on acid, resulting in better treatment efficiency, but chelating agents likewise may be too reactive at increased temperatures, giving either a too fast reaction or leading to an increased need to add additives to control and/or suppress undesired side effects.

For these reasons there is a need in the art to make treatment compositions that do not show the undesired behaviour of the state of the art fluids and that have a reduced corrosivity at high temperatures, show delayed reactivity with the formation in such a way that they react only after reaching the target zone, can increase the permeability of formations with a high permeability ratio by diverting the fluid to several zones in the formation during acidizing operations, and reduce the leak-off during treatments.

One way to achieve delayed reactivity is to emulsify an acidic treatment solution so that reduced or retarded acid reaction rates are provided. WO 2012/051007 discloses this for example for a number of common mineral acids such as hydrochloric acid, hydrofluoric acid, sulfuric acid, and a number of organic acids, such as acetic acid, and aminocarboxylic acids.

US 2003/0104950 proposes emulsifying aqueous treating compositions containing a chelating agent, such as EDTA, HEDTA, DTPA, HEIDA or NTA.

The present invention aims to provide improved compositions that are suitable for use in treating subterranean formations, that also have a retarded acid reaction rate, and that result in an improved treatment of the said formations.

The invention now provides a composition containing a dispersed phase emulsified in a continuous phase, wherein at least 5 wt % on total weight of the dispersed phase of the composition is a chelating agent selected from the group of glutamic acid N,N-diacetic acid or a salt thereof (GLDA), aspartic acid N,N-diacetic acid or a salt thereof (ASDA), and methylglycine N,N-diacetic acid or a salt thereof (MGDA). It was found that, contrary to many state of the art treatment acids, the chelating agents present in the emulsified compositions of this invention react multiple times slower than the same chelating agents in the dissolved state, which is a benefit when they are used in subterranean formations where the temperature is generally high and the chelating agents would otherwise react too rapidly with the formation to give a washout instead of forming a network of wormholes. Furthermore, it was found that the emulsified compositions of the invention have an excellent balance between the stability of the emulsion and an adjustable breakdown thereof, which is a benefit in formation treatment applications as then the emulsified compositions do not block or plug the less permeable parts of a formation unnecessarily long. Also for this reason in many embodiments the compositions of the invention need a lower amount of additives than state of the art acidic solutions.

Quite unexpectedly, it was found that the emulsified compositions of the invention give an improved permeability increase in treating subterranean formations when they are compared to emulsified chelating agent-containing compositions as described in the state of the art.

Additionally, it was found that during matrix-acidizing treatments the emulsified compositions of this invention are more readily diverted into the low-permeability zones, giving a more diverse network of wormholes or dissolution in formations with a high permeability ratio, i.e. formations with a heterogeneous permeability. This results in a better flow of gas or oil from both the initially high and the low-permeability zones. Due to the improved diversion a lower volume of acid is needed to conduct the matrix stimulation job.

Moreover, it was found that the emulsified composition was significantly less corrosive to the equipment especially at elevated temperatures, i.e. >350° F., compared to non-emulsified compositions containing chelating agents or state of the art emulsified acids, like HCl, as well as less temperature-sensitive.

Furthermore, it was found that the emulsified compositions of the invention are better at preventing fluid leak-off during treatments and require fewer fluid loss additives.

Because the emulsified compositions of the present invention require fewer additives they are commercially more attractive, as often increasing the amount of additives makes treatments very expensive

Finally, it was found that the emulsified compositions have an excellent combination of properties to improve the permeability of the formations by a combination of hydraulic and acid fracturing.

Accordingly, the present invention additionally provides a process for treating a subterranean formation comprising introducing a composition containing a dispersed phase emulsified in a continuous phase, wherein at least 5 wt % on total weight of the dispersed phase of the composition is a chelating agent selected from the group of glutamic acid N,N-diacetic acid or a salt thereof (GLDA), aspartic acid N,N-diacetic acid or a salt thereof (ASDA), and methylglycine N,N-diacetic acid or a salt thereof (MGDA), into the formation.

Furthermore, the present invention provides a process for treating a subterranean formation comprising introducing a composition into the formation, the composition containing a dispersed phase emulsified in a continuous phase containing at least 5 wt % on total weight of the dispersed phase of a chelating agent selected from the group of glutamic acid N,N-diacetic acid or a salt thereof (GLDA), aspartic acid N,N-diacetic acid or a salt thereof (ASDA), and methylglycine N,N-diacetic acid or a salt thereof (MGDA), and at least 0.01 vol % on total volume of the composition of an emulsifying agent.

Emulsified composition is defined in this application as a composition that is a mixture of a dispersed phase containing the chelating agent in a continuous phase, wherein the emulsified chelating agent does not dissolve in the continuous phase but will be dispersed in the continuous phase in small (aqueous) droplets. The emulsifier (also called: emulsifying agent) acts as a barrier between the dispersed phase and the continuous phase.

The dispersed phase containing the chelating agent can be released from the emulsion in various ways, including but not limited to treatments with demulsifying chemicals, changes in temperature, pH and/or pressure, and when the emulsion is squeezed through pores in the formation that are smaller than the droplet size of the aqueous dispersed phase containing the chelating agent.

It should be noted that a few documents, like U.S. Pat. No. 3,681,240, U.S. Pat. No. 2,681,889, and the above WO 2012/051007, disclose emulsions for treating a subterranean formation that contain an acidizing agent to retard their acid reactivity or to increase their stability. In WO 2012/051007 one of the disclosed emulsified compositions contains the chelating agent EDTA as an iron control agent; however, this document does no more than suggest that a chelating agent can be applied as an acidizing or acid-fracturing component and that the chelating agent is used in such high amounts as in the present invention. In addition, US 2008/0200354 discloses a breaker fluid, i.e. a fluid that is applied in removing filter cakes located in the wellbore originating from an oil based mud drilling operation, based on iminodiacetic acids, like for example GLDA. It is suggested that these breaker fluids can also be in the form of an emulsified composition; however, there is no clear and unambiguous disclosure as to how to prepare such emulsified compositions. Apart from that, this document does not disclose or hint at the use of emulsified compositions for treating a subterranean formation.

Surprisingly, it was found to be possible to make emulsified compositions containing chelating agents which are more suitable for treating a subterranean formation than those made from state of the art acidizing fluids like HCl-based fluids. Besides, it was found that the emulsified compositions containing the chelating agents of the present invention give a better performance in treating subterranean formations in that they give an improved permeability and require fewer further additives, which was not expected given the fact that chelating agents carry opposite charges in their molecular structure, i.e. contrary to many other acids they have a molecular structure in which the nitrogen atom is regularly slightly positively charged and the carboxylate group is negatively charged, depending on the pH of the solution.

Furthermore, it was found that more stable emulsions could be made based on the current invention, which makes these emulsions surprisingly effective for treating high-temperature (>300° F.) and horizontal wells.

Additionally, it was found that the droplet size of the emulsion containing the chelating agents could be more easily manipulated, enabling a person skilled in the art to adjust the treatment with the emulsified compositions described in this invention to the specific characteristics of the target zone of the formation and the intended treatment result.

The term treating in this application is intended to cover any treatment of the formation with the emulsified composition. It specifically covers treating the formation with the composition to achieve at least one of (i) an increased permeability, (ii) the removal of small particles, and (iii) the removal of inorganic scale, and so enhance the well performance and enable an increased production of oil and/or gas from the formation. At the same time, it may cover cleaning of the wellbore and descaling of the oil/gas production well and production equipment.

The amounts of chelating agent and emulsifying agent in wt % and vol %, respectively, are based on the total weight and volume, respectively, of the phase or composition in which they are present as indicated.

In addition, the present invention relates to a process of at least partially degrading a filter cake by contacting the emulsified composition with the filter cake, wherein the filter cake is formed by a water based drilling mud. In a preferred embodiment, the emulsified composition is circulated in the wellbore containing the filter cake. In another preferred embodiment, the emulsified composition contains from 0 mg/ml up to 20 mg/ml of an enzyme in the aqueous phase. The enzyme can additionally be introduced in the formation in a separate fluid before, in combination with, or after the treatment with the emulsified composition. More preferably the enzyme is introduced before the emulsified composition containing the chelating agent.

The subterranean formation in one embodiment can be a carbonate formation, a shale formation, or a sandstone formation and in a preferred embodiment is any of these formations with a A) high permeability ratio (>6D), in which case the major added advantage of the emulsified liquid of this invention is diversion, or B) a permeability <100 mD, in which case also fracturing can be applied, or C) when the temperature is >300° F., in which case the fluid of the invention shows reduced corrosion behaviour and slower reactivity resulting in less wash-out or face dissolution and a better relation between the volume of treatment fluid used and the increase in permeability.

Formations with a low permeability or formations that have a special design (like formations that are confined within shale layers) are often subjected to a fracturing operation, and in these operations the emulsified compositions of the present invention are also useful.

The chelating agent is preferably present in the dispersed phase of the composition in an amount of between 5 and 30 wt %, more preferably between 10 and 30 wt %, even more preferably between 15 and 25 wt %, on the basis of the total weight of the dispersed phase.

The emulsifying agent is preferably present in an amount of between 0.01 and 10 vol %, more preferably between 0.5 and 3.0 vol %, even more preferably between 1 and 2 vol %, on total volume of the composition.

The chelating agent in a preferred embodiment is GLDA, or ASDA, even more preferably GLDA.

The emulsifier can be a nonionic, anionic, cationic or amphoteric surfactant, polymeric surfactant or pickering emulsifier. Pickering emulsifiers are emulsifiers that stabilize an emulsion by relying on the effect of solid particles (for example colloidal silica) that adsorb onto the interface between the two phases.

It is common to express the property of a surfactant mixture by its hydrophilic-lipophilic balance, the so-called HLB. The HLB of non-ionic surfactants can be simply calculated by applying Griffin's formulae:

HLB=20×(molar mass of the hydrophilic portion of the molecule)/(molar mass of the molecule)

### Example

Decylalcohol ethoxylate (8EO): C₁₀-EO₈
Hydrophobic part: CH₃(CH₂)₉—OH molar mass=158
Hydrophilic part: [CH₂CH₂O]₈ molar mass=352
HLB for C₁₀-EO₈ is 20×352/(352+158)=13.8

The HLB of surfactants having ionic portions is calculated by Davis formulae rather than Griffin's:
HLB=7+Σ(Hydrophilic group contributions)−Σ(Hydrophobic group contributions), in which case the following tables need to be used in finding the increments, see Tables A-D in Technical Information Surface Chemistry: HLB & Emulsification, link: http://www.scrib.com/doc/56449546/HLB-Emulsification.

Table A has been retrieved:

TABLE A
anionic hydrophilic group contributions

| hydrophilic group | | hydrophilic group | |
|---|---|---|---|
| contribution | HLB | contribution | HLB |
| —COO—Na⁺ | 19.1 | —SO₃—Na⁺ | 20.7 |
| | | —O—SO₃—Na⁺ | 20.8 |

### Example

Tetradecyl ammonium chloride: C₁₄—N(CH₃)₃⁺Cl⁻

Group contributions of the hydrophobic groups:
—CH3: 1×0.475
—CH2-: 13×0.475

Group contributions of the hydrophilic groups:
—N(CH₃)₃⁺Cl⁻ 22.0
HLB for C₁₄—N(CH₃)₃⁺Cl⁻ is 7+22.0−(14×0.475)=22.4

The HLB of surfactant mixtures is simply the weight average of the HLBs of the individual surfactant types.

In one embodiment the HLB of the emulsifying agent is about 20 or below; preferably, the HLB is about 10 or below; and in another more preferred embodiment is about 8 or below.

In another embodiment, a suitable emulsion is obtained by including polymeric surfactants as emulsifiers. Examples of polymeric surfactants are partially hydrolyzed polyvinyl acetate, partially hydrolyzed modified polyvinyl acetate, block or co-polymers of polyethane, polypropane, polybutane or polypentane, proteins, and partially hydrolyzed polyvinyl acetate, polyacrylate and derivatives of polyacrylates, polyvinyl pyrrolidone and derivatives. The additional application of further surfactants to the polymeric surfactant is beneficial to the emulsion quality or lifetime.

Examples of emulsifiers include but are not limited to quaternary ammonium compounds (e.g., trimethyl tallow ammonium chloride, trimethyl coco ammonium chloride, dimethyl dicoco ammonium chloride, etc.), derivatives thereof, and combinations thereof, low HLB surfactants or oil-soluble surfactants. More specific suitable emulsifiers include, but are not necessarily limited to, polysorbates, alkyl sulfosuccinates, alkyl phenols, ethoxylated alkyl phenols, alkyl benzene sulfonates, fatty acids, ethoxylated fatty acids, propoxylated fatty acids, fatty acid salts, tall oils, castor oils, triglycerides, ethoxylated triglycerides, alkyl glucosides, and mixtures and derivatized fatty acids such as those disclosed in U.S. Pat. No. 6,849,581. Suitable polysorbates include, but are not necessarily limited to, sorbitan monolaurate, sorbitan monopalmitate, sorbitan monostearate, sorbitan monooleate, sorbitan monodecanoate, sorbitan monooctadecanoate, sorbitan trioleate and the like, and ethoxylated derivatives thereof. For instance, emulsifiers may have up to 20 ethoxy groups thereon. Suitable emulsifiers include stearyl alcohol, lecithin, fatty acid amines, ethoxylated fatty acid amines, and mixtures thereof. In some embodiments, more than one emulsifier may be used. Preferably, the emulsifier is cationic, such as an emulsifier that contains quaternary ammonium group-containing components.

The continuous phase is generally based on a hydrocarbon liquid in which the chelating agents do not dissolve, which in one embodiment is chosen from diesel, light crude oil, xylene, gasoline, toluene, kerosene, other aromatics, refined hydrocarbons, and mixtures thereof. In preferred embodiments, the continuous phase is chosen from the group of xylene, diesel, light crude oil or mixtures thereof. Xylene is preferred if an asphaltene is present in the composition.

The process of the invention is preferably performed at a temperature of between 35 and 400° F. (about 2 and 204° C.). More preferably, the compositions are used at a temperature where they best achieve the desired effects, which means a temperature of between 100 and 400° F. (about 27 and 204° C.), most preferably between 200 and 400° F. (about 93 and 204° C.).

The process of the invention when it is a matrix-acidizing treatment process is preferably performed at a pressure between atmospheric pressure and fracture pressure, wherein fracture pressure is defined as the pressure above which the injection of compositions will cause the formation to fracture hydraulically, and when it is a fracturing process is preferably performed at a pressure above the fracture pressure of the producing zone(s). A person skilled in the art will understand that the fracturing pressure depends on parameters such as the type, depth of the formation, and downhole stresses and can be different for any reservoir.

In one embodiment of the process of the invention, the emulsified composition is introduced in the formation at 0.1 to 4 barrels/ft (52 to 2,087 l/m) of target zone, preferably 0.25 to 3 barrels/ft (130 to 1,565 l/m), even more preferably 0.5 to 2 barrels/ft (261 to 1,043 l/m). In this document, the target zone is defined as that part of the wellbore which is treated by the emulsified composition of the invention and includes but is not limited to the part of the wellbore where the water based filter cake is located or that part of the wellbore treated with the composition of the invention to improve more oil or gas production.

In yet another embodiment, the process of the invention contains a soaking step. A soaking step is defined as a step wherein the formation is contacted with the composition while reducing the flow with which the composition is moved through the formation to allow the composition time to react with the components in the formation. In another preferred embodiment the process contains more than one soaking step.

There are several ways to achieve a soaking step. Because normally the treatment composition is pumped into the formation, the most preferred step involves just reducing the pumping speed or completely switching off the pumps for a period of time, while keeping the pressure at least equal to the formation pressure, in order to avoid flowback of liquids or gas from the formation into the wellbore. The period of time for the reduced flow, i.e. the soaking step, is suitably between about 10 minutes and 24 hours, and preferably 30 minutes to 12 hours, more preferably 1 to 6 hours.

Salts of GLDA, ASDA, and MGDA that can be used are the alkali metal, alkaline earth metal, or ammonium full and partial salts. Also mixed salts containing different cations can be used. Preferably, the sodium, potassium, and ammonium full or partial salts of GLDA, ASDA, and MGDA are used.

The compositions of the dispersed phase of this invention are preferably aqueous, i.e., they preferably contain water as a solvent for the chelating agent, wherein water can be, e.g., fresh water, aquifer water, produced water, seawater or any combinations of these waters, as long as it does not hinder the initial formation of the emulsion, and such that the chelating agent is first dissolved in an aqueous medium and then emulsified in the continuous phase which contains the emulsifying agent. Preferably, the continuous phase is present in an amount of at least 10 vol % on total composition volume. Typically, the volume ratio between the dispersed phase and the continuous phase is between 80:20 and 50:50, preferably about 70:30, although other ratios are possible.

In one embodiment, the pH of the dispersed phase of the invention and as used in the process can range from 1.7 to 14. Preferably, however, it is between 2 and 13, as in the very alkaline range of 13 to 14 some undesired side effects may be caused by the compositions in the formation, such as an increased risk of reprecipitation. For a better carbonate dissolving capacity the dispersed phase is preferably acidic. On the other hand, it must be realized that highly acidic solutions are more expensive to prepare and are more corrosive to well completion and tubulars, especially at high temperatures. Consequently, the dispersed phase of the composition even more preferably has a pH of 3.5 to 6.

The emulsified composition may contain other additives that improve the functionality of the stimulation action and minimize the risk of damage as a consequence of the said treatment, as is known to anyone skilled in the art. It should be understood that the several additives can be part of a main treatment composition but can be included equally well in a preflush or postflush composition. In such embodiments the composition of the invention is effectively a kit of parts wherein each part contains part of the components of the total composition, for example, one part that is used for the main treatment contains the emulsified composition of the invention and one or more other parts contain one or more of the other additives, such as for example a surfactant, enzyme, or mutual solvent.

The emulsified composition of the invention may in addition contain one or more of the group of anti-sludge agents, (water-wetting or emulsifying) surfactants, corrosion inhibitors, mutual solvents, corrosion inhibitor intensifiers, additional foaming agents, viscosifiers, wetting agents, diverting agents, oxygen scavengers, carrier fluids, fluid loss additives, friction reducers, stabilizers, rheology modifiers, gelling agents, scale inhibitors, breakers, salts, brines, pH control additives such as further acids and/or bases, bactericides/biocides, particulates, crosslinkers, salt substitutes (such as tetramethyl ammonium chloride), relative permeability modifiers, sulfide scavengers, fibres, nanoparticles, consolidating agents (such as resins and/or tackifiers), combinations thereof, or the like.

The mutual solvent is a chemical additive that is soluble in oil, water, acids (often HCl-based), and other well treatment fluids (see also http://www.glossary.oilfield.slb.com). Mutual solvents are routinely used in a range of applications, controlling the wettability of contact surfaces before, during and/or after a treatment, and preventing or breaking up emulsions. Mutual solvents are used, as insoluble formation fines pick up organic film from crude oil. These particles are partially oil-wet and partially water-wet. This causes them to collect materials at any oil-water interface, which can stabilize various oil-water emulsions. Mutual solvents remove organic films leaving them water-wet, thus emulsions and particle plugging are eliminated. If a mutual solvent is employed for emulsified acids as covered by the present invention, it needs to be used in a preflush or postflush fluid as it is generally not compatible with the emulsifying agent. If it is used, it is preferably selected from the group which includes, but is not limited to, lower alcohols such as methanol, ethanol, 1-propanol, 2-propanol, and the like, glycols such as ethylene glycol, propylene glycol, diethylene glycol, dipropylene glycol, polyethylene glycol, polypropylene glycol, polyethylene glycol-polyethylene glycol block copolymers, and the like, and glycol ethers such as 2-methoxyethanol, diethylene glycol monomethyl ether, and the like, substantially water/oil-soluble esters, such as one or more C2-esters through C10-esters, and substantially water/oil-soluble ketones, such as one or more C2-C10 ketones, wherein substantially soluble means soluble in more than 1 gram per liter, preferably more than 10 grams per liter, even more preferably more than 100 grams per liter, most preferably more than 200 grams per liter.

A preferred water/oil-soluble ketone is methylethyl ketone.

A preferred substantially water/oil-soluble alcohol is methanol.

A preferred substantially water/oil-soluble ester is methyl acetate.

A more preferred mutual solvent is ethylene glycol monobutyl ether, generally known as EGMBE

The surfactant (both water-wetting surfactants as well as surfactants used as foaming agent, viscosifying agent or emulsifying agent) can be any surfactant known in the art and include anionic, cationic, amphoteric, and nonionic surfactants. The choice of surfactant is initially also determined by the nature of the rock formation around the well. The application of cationic surfactants is best limited in the case of sandstone, while in the case of carbonate rock, anionic surfactants are not preferred. Hence, the surfactant (mixture) is preferably predominantly anionic in nature when the formation is a sandstone formation. When the formation is a carbonate formation, the surfactant (mixture) is preferably predominantly nonionic or cationic in nature, even more preferably predominantly cationic.

The nonionic surfactant of the present composition is preferably selected from the group consisting of alkanolamides, alkoxylated alcohols, alkoxylated amines, amine oxides, alkoxylated amides, alkoxylated fatty acids, alkoxylated fatty amines, alkoxylated alkyl amines (e.g., cocoalkyl amine ethoxylate), alkyl phenyl polyethoxylates, lecithin, hydroxylated lecithin, fatty acid esters, glycerol esters and their ethoxylates, glycol esters and their ethoxylates, esters of propylene glycol, sorbitan, ethoxylated sorbitan, polyglycosides, and the like, and mixtures thereof. Alkoxylated alcohols, preferably ethoxylated alcohols, optionally in combination with (alkyl)polyglycosides, are the most preferred nonionic surfactants.

The anionic surfactants may comprise any number of different compounds, including alkyl sulfates, alkyl sulfonates, alkylbenzene sulfonates, alkyl phosphates, alkyl phosphonates, alkyl sulfosuccinates.

The amphoteric surfactants include hydrolyzed keratin, taurates, sultaines, phosphatidylcholines, betaines, modified betaines, alkylamidobetaines (e.g., cocoamidopropyl betaine).

The cationic surfactants include alkyl amines, alkyl dimethylamines, alkyl trimethylamines (quaternary amines), alkyl diethanolamines, dialkyl amines, dialkyl dimethylamines, and less common classes based on phosphonium, sulfonium. In preferred embodiments, the cationic surfactants may comprise quaternary ammonium compounds (e.g., trimethyl tallow ammonium chloride, trimethyl coco ammonium chloride), derivatives thereof, and combinations thereof.

Examples of surfactants that are also foaming agents that may be utilized to foam and stabilize the treatment compositions of this invention include, but are not limited to, betaines, amine oxides, methyl ester sulfonates, alkylamidobetaines such as cocoamidopropyl betaine, alpha-olefin sulfonate, trimethyl tallow ammonium chloride, C8 to C22 alkyl ethoxylate sulfate, and trimethyl coco ammonium chloride.

The foaming agent, if used, is normally used in an amount of between 10 and 200,000 ppm based on the total weight of the composition, preferably between 100 and 10,000 ppm.

In another embodiment, the compositions of the present invention may comprise a foam extender, as for example disclosed in WO 2007/020592.

Suitable surfactants may be used in a liquid or solid form, like a powder, granule or particulate form.

Where used, the surfactants may be present in the composition in an amount sufficient to prevent incompatibility with formation fluids, other treatment fluids, or wellbore fluids at reservoir temperature.

In an embodiment where liquid surfactants are used, the surfactants are generally present in an amount in the range of from about 0.01% to about 5.0% by volume of the composition.

In one embodiment, the liquid surfactants are present in an amount in the range of from about 0.1% to about 2.0% by volume of the composition, more preferably between 0.1 and 1 vol %.

In embodiments where powdered surfactants are used, the surfactants may be present in an amount in the range of from about 0.001% to about 0.5% by weight of the composition.

The anti-sludge agent can be chosen from the group of mineral and/or organic acids used to stimulate sandstone hydrocarbon-bearing formations. The function of the acid is to dissolve acid-soluble materials so as to clean or enlarge the flow channels of the formation leading to the wellbore, allowing more oil and/or gas to flow to the wellbore.

Problems can be caused by the interaction of the (usually concentrated, 20-28%) stimulation acid and certain crude oils (e.g. asphaltic oils) in the formation to form sludge. Interaction studies between sludging crude oils and the introduced acid show that permanent, rigid solids are formed at the acid-oil interface when the aqueous phase is below a pH of about 4. No films are observed for non-sludging crudes with acid.

These sludges are usually reaction products formed between the acid and the high-molecular weight hydrocarbons such as asphaltenes, resins, etc.

Methods for preventing or controlling sludge formation with its attendant flow problems during the acidization of crude-containing formations include adding “anti-sludge” agents to prevent or reduce the rate of formation of crude oil sludge, which anti-sludge agents stabilize the acid-oil emulsion and include alkyl phenols, fatty acids, and anionic surfactants. Frequently used as the surfactant is a blend of a sulfonic acid derivative and a dispersing surfactant in a solvent. Such a blend generally has dodecyl benzene sulfonic acid (DDBSA) or a salt thereof as the major dispersant, i.e. anti-sludge, component.

The carrier fluids are aqueous solutions which in certain embodiments contain a Bronsted acid to keep the pH in the desired range and/or contain an inorganic salt, preferably NaCl or KCl.

Corrosion inhibitors may be selected from the group of amine and quaternary ammonium compounds and sulfur compounds. Examples are diethyl thiourea (DETU), which is suitable up to 185° F. (about 85° C.), alkyl pyridinium or quinolinium salt, such as dodecyl pyridinium bromide (DDPB), and sulfur compounds, such as thiourea or ammonium thiocyanate, which are suitable for the range 203-302° F. (about 95-150° C.), benzotriazole (BZT), benzimidazole (BZI), dibutyl thiourea, a proprietary inhibitor called TIA, and alkyl pyridines.

In general, the most successful inhibitor formulations for organic acids and chelating agents contain amines, reduced sulfur compounds or combinations of a nitrogen compound (amines, quats or polyfunctional compounds) and a sulfur compound. The amount of corrosion inhibitor is preferably between 0.1 and 2 vol %, more preferably between 0.1 and 1 vol % on the total emulsified composition.

One or more corrosion inhibitor intensifiers may be added, such as for example formic acid, potassium iodide, antimony chloride, or copper iodide.

One or more salts may be used as rheology modifiers to further modify the rheological properties (e.g., viscosity and elastic properties) of the compositions. These salts may be organic or inorganic.

Examples of suitable organic salts include, but are not limited to, aromatic sulfonates and carboxylates (such as p-toluene sulfonate and naphthalene sulfonate), hydroxynaphthalene carboxylates, salicylate, phthalate, chlorobenzoic acid, phthalic acid, 5-hydroxy-1-naphthoic acid, 6-hydroxy-1-naphthoic acid, 7-hydroxy-1-naphthoic acid, 1-hydroxy-2-naphthoic acid, 3-hydroxy-2-naphthoic acid, 5-hydroxy-2-naphthoic acid, 7-hydroxy-2-naphthoic acid, 1,3-dihydroxy-2-naphthoic acid, 3,4-dichlorobenzoate, trimethyl ammonium hydrochloride, and tetramethyl ammonium chloride.

Examples of suitable inorganic salts include water-soluble potassium, sodium, and ammonium halide salts (such as potassium chloride and ammonium chloride), calcium chloride, calcium bromide, magnesium chloride, sodium formate, potassium formate, cesium formate, and zinc halide salts. A mixture of salts may also be used, but it should be noted that preferably chloride salts are mixed with chloride salts, bromide salts with bromide salts, and formate salts with formate salts.

Wetting agents that may be suitable for use in this invention include crude tall oil, oxidized crude tall oil, surfactants, organic phosphate esters, modified imidazolines and amidoamines, alkyl aromatic sulfates and sulfonates, and the like, and combinations or derivatives of these and similar such compounds that should be well known to one of skill in the art.

When a viscosifier is used, the viscosifier is preferably present in an amount of between 0.01 and 3 wt %, more preferably between 0.01 and 2 wt %, even more preferably between 0.05 and 1.5 wt % on total weight of the composition.

The viscosifier in one embodiment can be chosen from carbohydrates, or from polysaccharides such as cellulosic derivatives, guar or guar derivatives, xanthan, carrageenan, starch biopolymers, several gums, polyacrylamides, polyacrylates, viscoelastic surfactants [e.g. amide oxides, carboxybetaines].

When a viscosifier is present, the compositions may in addition contain a crosslinking agent capable of crosslinking the viscosifier and thereby improving the properties of the composition. Crosslinking agents are for example disclosed in WO 2007/020592.

The viscosifiers include chemical species which are soluble, at least partially soluble and/or insoluble in the chelating agent-containing starting fluid. The viscosifiers may also include various insoluble or partially soluble organic and/or inorganic fibres and/or particulates, e.g., dispersed clay, dispersed minerals, and the like, which are known in the art to increase viscosity. Suitable viscosifiers further include various organic and/or inorganic polymeric species including polymer viscosifying agents, especially metal-crosslinked polymers. Suitable polymers for making the metal-crosslinked polymer viscosifiers include, for example, polysaccharides, e.g., cellulosic derivatives, substituted galactomannans, such as guar gums, high-molecular weight polysaccharides composed of mannose and galactose sugars, or guar derivatives such as hydroxypropyl guar (HPG), carboxymethyl hydroxypropyl guar (CMHPG), and carboxymethyl guar (CMG), hydrophobically modified guars, guar-containing compounds, and synthetic polymers. Crosslinking agents which include boron, titanium, zirconium and/or aluminium complexes are preferably used to increase the effective molecular weight of the polymers and make them better suited for use as viscosity-increasing agents, especially in high-temperature wells. Other suitable classes of water-soluble polymers effective as viscosifiers include polyvinyl alcohols at various levels of hydrolysis, polyvinyl polymers, polymethacrylamides, cellulose ethers, lignosulfonates, and ammonium, alkali metal, and alkaline earth salts thereof, polyethylene imines, polydiallyl dimethyl ammonium chloride, polyamines like copolymers of dimethylamine and epichlorohydrin, copolymers of acrylamide and cationic monomers, like diallyl dimethyl ammonium chloride (DADMAC) or acryloyloxyethyl trimethyl ammonium chloride, copolymers of acrylamide containing anionic as well as cationic groups. More specific examples of other typical water-soluble polymers are acrylic acid-acrylamide copolymers, acrylic acid-methacrylamide copolymers, polyacrylamides, partially hydrolyzed polyacrylamides, partially hydrolyzed polymethacrylamides, polyvinyl alcohol, polyalkylene oxides, other galactomannans, heteropolysaccharides obtained by the fermentation of starch-derived sugar and ammonium and alkali metal salts thereof. Cellulose derivatives, including hydroxyethyl cellulose (HEC), hydroxypropyl cellulose (HPC), carboxymethylhydroxyethyl cellulose (CMHEC) and/or carboxymethyl cellulose (CMC), with or without crosslinkers, xanthan, diutan, and scleroglucan are also preferred.

Still other viscosifiers include clay-based viscosifiers, platy clays, like bentonites, hectorites or laponites, and small fibrous clays such as the polygorskites (attapulgite and sepiolite). When using polymer-containing viscosifiers as further viscosifiers, the viscosifiers may be used in an amount of up to 5% by weight of the compositions of the invention.

Examples of suitable brines include calcium bromide brines, zinc bromide brines, calcium chloride brines, sodium chloride brines, sodium bromide brines, potassium bromide brines, potassium chloride brines, sodium nitrate brines, sodium formate brines, potassium formate brines, cesium formate brines, magnesium chloride brines, sodium sulfate, potassium nitrate, and the like. A mixture of salts may also be used in the brines, but it should be noted that preferably chloride salts are mixed with chloride salts, bromide salts with bromide salts, and formate salts with formate salts.

The brine chosen should be compatible with the formation and should have a sufficient density to provide the appropriate degree of well control.

Additional salts may be added to a water source, e.g., to provide a brine, and a resulting treatment composition, in order to have a desired density.

The amount of salt to be added should be the amount necessary for formation compatibility, such as the amount necessary for the stability of clay minerals, taking into consideration the crystallization temperature of the brine, e.g., the temperature at which the salt precipitates from the brine as the temperature drops.

Preferred suitable brines may include seawater and/or formation brines.

Salts may optionally be included in the composition of the present invention for many purposes, including for reasons related to compatibility of the composition with the formation and the formation fluids.

To determine whether a salt may be beneficially used for compatibility purposes, a compatibility test may be performed to identify potential compatibility problems.

From such tests, one of ordinary skill in the art will, with the benefit of this disclosure, be able to determine whether a salt should be included in a composition of the present invention.

Suitable salts include, but are not limited to, calcium chloride, sodium chloride, magnesium chloride, potassium chloride, sodium bromide, potassium bromide, ammonium chloride, sodium formate, potassium formate, cesium formate, and the like. A mixture of salts may also be used, but it should be noted that preferably chloride salts are mixed with chloride salts, bromide salts with bromide salts, and formate salts with formate salts.

The amount of salt to be added should be the amount necessary for the required density for formation compatibility, such as the amount necessary for the stability of clay minerals, taking into consideration the crystallization temperature of the brine, e.g., the temperature at which the salt precipitates from the brine as the temperature drops.

Salt may also be included to increase the viscosity of the composition and stabilize it, particularly at temperatures above 180° F. (about 82° C.).

Examples of suitable pH control additives which may optionally be included in the composition of the present invention are acids and/or bases.

A pH control additive may be necessary to maintain the pH of the composition at a desired level, e.g., to improve the effectiveness of certain breakers and to reduce corrosion on any metal present in the wellbore or formation, etc.

One of ordinary skill in the art will, with the benefit of this disclosure, be able to recognize a suitable pH for a particular application.

In one embodiment, the pH control additive may be an acidic composition.

Examples of suitable acids may comprise an acid, an acid-generating compound, and combinations thereof.

Any known acid may be suitable for use with the compositions of the present invention.

Examples of acids that may be suitable for use in the present invention include, but are not limited to, organic acids (e.g., formic acids, acetic acids, carbonic acids, citric acids, glycolic acids, lactic acids, p-toluene sulfonic acid, ethylene diamine tetraacetic acid (EDTA), hydroxyethyl ethylene diamine triacetic acid (HEDTA), and the like), inorganic acids (e.g., hydrochloric acid, hydrofluoric acid, phosphonic acid, and the like), and combinations thereof. Preferred acids are HCl (in an amount compatible with the illite content) and organic acids.

Examples of acid-generating compounds that may be suitable for use in the present invention include, but are not limited to, esters, aliphatic polyesters, ortho esters, which may also be known as ortho ethers, poly(ortho esters), which may also be known as poly(ortho ethers), poly(lactides), poly(glycolides), poly(epsilon-caprolactones), poly(hydroxybutyrates), poly(anhydrides), or copolymers thereof. Derivatives and combinations also may be suitable.

The term “copolymer” as used herein is not limited to the combination of two polymers, but includes any combination of polymers, e.g., terpolymers and the like. Other suitable acid-generating compounds include: esters including, but not limited to, ethylene glycol monoformate, ethylene glycol diformate, diethylene glycol diformate, glyceryl monoformate, glyceryl diformate, glyceryl triformate, methylene glycol diformate, and formate esters of pentaerythritol.

The pH control additive also may comprise a base to elevate the pH of the composition.

Generally, a base may be used to elevate the pH of the mixture to greater than or equal to about 7.

Having the pH level at or above 7 may have a positive effect on a chosen breaker being used and may also inhibit the corrosion of any metals present in the wellbore or formation, such as tubing, screens, etc.

In addition, having a pH greater than 7 may also impart greater stability to the viscosity of the treatment composition, thereby enhancing the length of time that viscosity can be maintained.

This could be beneficial in certain uses, such as in longer-term well control and in diverting.

Any known base that is compatible with the components in the emulsified compositions of the present invention can be used in the emulsified compositions of the present invention.

Examples of suitable bases include, but are not limited to, sodium hydroxide, potassium carbonate, potassium hydroxide, sodium carbonate, and sodium bicarbonate.

One of ordinary skill in the art will, with the benefit of this disclosure, recognize the suitable bases that may be used to achieve a desired pH elevation.

In some embodiments, the composition may optionally comprise a further chelating agent.

When added, the chelating agent may chelate any dissolved iron (or other divalent or trivalent cations) that may be present and prevent any undesired reactions being caused.

Such a chelating agent may, e.g., prevent such ions from crosslinking the gelling agent molecules.

Such crosslinking may be problematic because, inter alia, it may cause filtration problems, injection problems and/or again cause permeability problems.

Any suitable chelating agent may be used with the present invention.

Examples of suitable chelating agents include, but are not limited to, citric acid, nitrilotriacetic acid (NTA), any form of ethylene diamine tetraacetic acid (EDTA), hydroxyethyl ethylene diamine triacetic acid (HEDTA), diethylene triamine pentaacetic acid (DTPA), propylene diamine tetraacetic acid (PDTA), ethylene diamine-N,N″-di(hydroxyphenyl) acetic acid (EDDHA), ethylene diamine-N,N″-di-(hydroxy-methylphenyl) acetic acid (EDDHMA), ethanol diglycine (EDG), trans-1,2-cyclohexylene dinitrilotetraacetic acid (CDTA), glucoheptonic acid, gluconic acid, sodium citrate, phosphonic acid, salts thereof, and the like.

In some embodiments, the chelating agent may be a sodium or potassium salt. Generally, the chelating agent may be present in an amount sufficient to prevent undesired side effects of divalent or trivalent cations that may be present, and thus also functions as a scale inhibitor.

One of ordinary skill in the art will, with the benefit of this disclosure, be able to determine the proper concentration of a chelating agent for a particular application.

In some embodiments, the compositions of the present invention may contain bactericides or biocides, inter alia, to protect the subterranean formation as well as the composition from attack by bacteria. Such attacks can be problematic because they may lower the viscosity of the composition, resulting in poorer performance, such as poorer sand suspension properties, for example.

Any bactericides known in the art are suitable. Biocides and bactericides that protect against bacteria that may attack GLDA, ASDA, or MGDA or sulfates are preferred.

An artisan of ordinary skill will, with the benefit of this disclosure, be able to identify a suitable bactericide and the proper concentration of such bactericide for a given application.

Examples of suitable bactericides and/or biocides include, but are not limited to, phenoxyethanol, ethylhexyl glycerine, benzyl alcohol, methyl chloroisothiazolinone, methyl isothiazolinone, methyl paraben, ethyl paraben, propylene glycol, bronopol, benzoic acid, imidazolinidyl urea, a 2,2-dibromo-3-nitrilopropionamide, and a 2-bromo-2-nitro-1,3-propane diol. In one embodiment, the bactericides are present in the composition in an amount in the range of from about 0.001% to about 1.0% by weight of the composition.

Compositions of the present invention also may comprise breakers capable of assisting in the reduction of the viscosity of the emulsified composition at a desired time.

Examples of such suitable breakers for the present invention include, but are not limited to, oxidizing agents such as sodium chlorites, sodium bromate, hypochlorites, perborate, persulfates, and peroxides, including organic peroxides. Other suitable breakers include, but are not limited to, suitable acids and peroxide breakers, triethanol amine, as well as enzymes that may be effective in breaking. The breakers can be used as is or encapsulated.

Examples of suitable acids may include, but are not limited to, hydrochloric acid, hydrofluoric acid, formic acid, acetic acid, citric acid, lactic acid, glycolic acid, chlorous acid, etc.

A breaker may be included in the composition of the present invention in an amount and form sufficient to achieve the desired viscosity reduction at a desired time.

The breaker may be formulated to provide a delayed break, if desired.

The compositions of the present invention also may comprise suitable fluid loss additives.

Such fluid loss additives may be particularly useful when a composition of the present invention is used in a fracturing application or in a composition that is used to seal a formation against invasion of fluid from the wellbore.

Any fluid loss agent that is compatible with the compositions of the present invention is suitable for use in the present invention.

Examples include, but are not limited to, starches, silica flour, gas bubbles (energized fluid or foam), benzoic acid, soaps, resin particulates, relative permeability modifiers, degradable gel particulates, diesel or other hydrocarbons dispersed in fluid, and other immiscible fluids.

Another example of a suitable fluid loss additive is one that comprises a degradable material.

Suitable examples of degradable materials include polysaccharides such as dextran or cellulose; chitins; chitosans; proteins; aliphatic polyesters; poly(lactides); poly(glycolides); poly(glycolide-co-lactides); poly(epsilon-caprolactones); poly(3-hydroxybutyrates); poly(3-hydroxybutyrate-co-hydroxyvalerates); poly(anhydrides); aliphatic poly(carbonates); poly(ortho esters); poly(amino acids); poly(ethylene oxides); poly(phosphazenes); derivatives thereof; or combinations thereof.

In some embodiments, a fluid loss additive may be included in an amount of about 5 to about 2,000 lbs/Mgal (about 600 to about 240,000 g/Mliter) of the composition.

In some embodiments, the fluid loss additive may be included in an amount from about 10 to about 50 lbs/Mgal (about 1,200 to about 6,000 g/Mliter) of the composition.

In certain embodiments, a stabilizer may optionally be included in the compositions of the present invention.

It may be particularly advantageous to include a stabilizer if a (too) rapid viscosity degradation is experienced.

One example of a situation where a stabilizer might be beneficial is where the BHT (bottom hole temperature) of the wellbore is sufficient to break the composition by itself without the use of a breaker.

Suitable stabilizers include, but are not limited to, sodium thiosulfate, methanol, and salts such as formate salts and potassium or sodium chloride.

Such stabilizers may be useful when the compositions of the present invention are utilized in a subterranean formation having a temperature above about 200° F. (about 93° C.). If included, a stabilizer may be added in an amount of from about 1 to about 50 lbs/Mgal (about 120 to about 6,000 g/Mliter) of composition.

Scale inhibitors may be added, for example, when the compositions of the invention are not particularly compatible with the formation waters in the formation in which they are used.

These scale inhibitors may include water-soluble organic molecules with carboxylic acid, aspartic acid, maleic acids, sulfonic acids, phosphonic acid, and phosphate ester groups including copolymers, ter-polymers, grafted copolymers, and derivatives thereof.

Examples of such compounds include aliphatic phosphonic acids such as diethylene triamine penta(methylene phosphonate) and polymeric species such as polyvinyl sulfonate.

The scale inhibitor may be in the form of the free acid but is preferably in the form of mono- and polyvalent cation salts such as Na, K, Al, Fe, Ca, Mg, NH₄. Any scale inhibitor that is compatible with the composition in which it will be used is suitable for use in the present invention.

Suitable amounts of scale inhibitors that may be included may range from about 0.05 to 100 gallons per about 1,000 gallons (i.e. 0.05 to 100 liters per 1,000 liters) of the composition.

Any particulates such as proppant, gravel that are commonly used in subterranean operations may be used in the present invention (e.g., sand, gravel, bauxite, ceramic materials, glass materials, wood, plant and vegetable matter, nut hulls, walnut hulls, cotton seed hulls, cement, fly ash, fibrous materials, composite particulates, hollow spheres and/or porous proppant).

It should be understood that the term “particulate” as used in this disclosure includes all known shapes of materials including substantially spherical materials, oblong, fibre-like, ellipsoid, rod-like, polygonal materials (such as cubic materials), mixtures thereof, derivatives thereof, and the like.

In some embodiments, coated particulates may be suitable for use in the treatment compositions of the present invention. It should be noted that many particulates also act as diverting agents. Further diverting agents are viscoelastic surfactants and in-situ gelled fluids.

Oxygen scavengers may be needed to enhance the thermal stability of the chelating agent. Examples thereof are sulfites and ethorbates.

Friction reducers can be added in an amount of up to 0.2 vol %. Suitable examples are viscoelastic surfactants and enlarged molecular weight polymers.

Further crosslinkers can be chosen from the group of multivalent cations that can crosslink polymers such as Al, Fe, B, Ti, Cr, and Zr, or organic crosslinkers such as polyethylene amides, formaldehyde.

Sulfide scavengers can suitably be an aldehyde or ketone.

Viscoelastic surfactants can be chosen from the group of amine oxides or carboxyl butane-based surfactants.

High-temperature applications may benefit from the presence of an oxygen scavenger in an amount of less than about 2 vol % of the solution.

In the process of the invention the composition can be flooded back from the formation. Even more preferably, (part of) the composition is recycled.

It must be realized, however, that GLDA, ASDA, and MGDA, being biodegradable chelating agents, will not completely flow back and therefore are not recyclable to the full extent.

The invention is further illustrated by the Examples below.

### EXAMPLES

### Example 1

### Preparation of an Emulsified Composition with GLDA

A cationic emulsifier was used to prepare an emulsified GLDA composition. The emulsified GLDA composition was formulated with 70 vol % GLDA-containing aqueous phase and 30 vol % diesel. The GLDA concentration of the aqueous phase was 20 wt %. The rheology of the new emulsified GLDA was studied using a Grace M5600 HPHT rheometer. The measurements were conducted at a temperature of 75° F. (24° C.), and for an emulsifier concentration of 1.0 vol % (with respect to the final solution volume).

### Materials

The emulsions were prepared using diesel and GLDA solution. The water used throughout the experiments was de-ionized water, obtained from a purification water system that has a resistivity of 18.2 MΩ·cm at room temperature. GLDA solutions with an initial concentration of 40 wt % were obtained from Akzo Nobel Functional Chemicals LLC. A cationic emulsifier Arquad® 2C-75 ex AkzoNobel Surface Chemistry LLC was used to prepare the emulsified GLDA systems.

### Procedures

A solution of GLDA with a concentration of 20 wt % and pH of 3.8 was prepared from above GLDA solution by adding deionized water. The diesel solution was prepared by adding the cationic emulsifier to diesel oil, and mixing at a high speed of 1,000 rpm. Then, the GLDA solution was added slowly to the diesel solution and mixed at high speed for 30 min.

### Equipment

A HPHT rheometer was used to measure the viscosity of the emulsified GLDA. The wetted material is Hastelloy C-276, an acid-resistant alloy. The rheometer can perform measurements at various temperatures up to 500° F. (260° C.) over shear rates of 0.00004 to 1,870 s⁻¹. A B5 bob was used in this work, which required a sample volume of 52 cm³. The test was applied by varying the shear rate from 0.1 to 1,000 s⁻¹

### Results

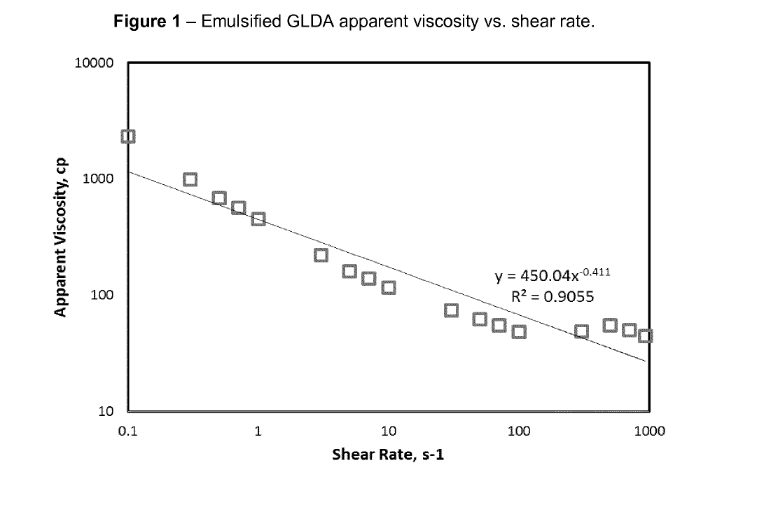

The emulsified GLDA was prepared at 1.0 vol % emulsifier concentration, resulting in a homogeneous emulsion. The effect of increasing the shear rate on the apparent viscosity of emulsified GLDA was studied using a Grace M5600 HPHT rheometer. The apparent viscosity of the emulsified GLDA decreased as the shear rate increased, see FIG. 1. The apparent viscosity as a function of shear rate can be represented by a straight line on a log-log plot, indicating a non-Newtonian shear thinning behaviour that can be fitted using a power-law model. The power-law model states that:

μₐ=K\dot{γ}ⁿ⁻¹

where μₐ is the apparent viscosity, \dot{γ} is the shear rate (s⁻¹), K is the power-law constant (mPa·sⁿ), and n is the power-law index. Table 1 lists the values for K, n, and the correlating coefficient for the emulsified GLDA, prepared at 1.0 vol % emulsifier. The correlating coefficient indicated a good correlation of the apparent viscosity and shear rate.

TABLE 1
Summary of power-law model parameters for emulsified
GLDA at 75° F. (24° C.).

| Emulsifier | Power-law Constant, | Power-law | Correlating |
|---|---|---|---|
| Concentration (vol %) | K (mPa · sⁿ) | Index, n | Coefficient |
| 1.0 | 482.6 | 0.454 | 0.98 |

### Examples 2 to 4 Preparation of an Emulsified Composition with GLDA and HEDTA-Comparison of Emulsified GLDA with Non-Emulsified GLDA and with Emulsified HEDTA

### Experimental Methods

### Materials

GLDA and HEDTA with a concentration of 20 wt % and pH of 3.8 were prepared from original solutions that were obtained from AkzoNobel. The original GLDA and HEDTA concentrations were 38 wt %. Deionized water, obtained from a water purification system which has a resistivity of 18.2 MΩ·cm at room temperature, was used to prepare the 20 wt % GLDA and HEDTA solutions. The emulsified GLDA and HEDTA solutions were prepared using diesel, an emulsifier, and 20 wt % GLDA or HEDTA solution. In all emulsion preparations, the same source of diesel was used. A cationic emulsifier, Armostim H-mul ex AkzoNobel Surface Chemistry LLC, was used in an amount of 1 vol % on total emulsions. The emulsifier was premixed with a small amount of isopropanol and a petroleum distillate, to make it easier to distribute in the emulsion.

### Cores and Disk Preparation

Indiana limestone block was obtained from a local company. Core samples were cut as 6 in. (15.24 cm) long cores of 1.5 in. (3.81 cm) diameter. The rock composition was determined by X-ray fluorescence (XRF). Elemental analysis showed that the limestone core samples contained more than 98 wt % calcite with some traces of clays and quartz. The cores were dried in an oven at a temperature of 150° C. (302° F.) for 3 hours until they had dried completely. The cores were weighed using a digital balance to obtain the dry weight of the core samples. After that, the dried cores were saturated with deionized water under vacuum for 24 hours and the weight of the water-saturated cores was measured, and the pore volume and hence the core porosity were calculated. The cores were put in a core holder, and water was injected at different flow rates. For each flow rate, the pressure drop after stabilization was recorded. A plot of flow rate divided by the core cross-sectional area vs. the ratio of pressure drop to core length was used to calculate the initial core permeability.

Disks with a diameter of 1.5 in. (3.81 cm) and a thickness of 0.75 in. (1.91 cm) were cut and tested using the rotating disk apparatus. The porosity of all core plugs was measured and found to be in the range of 13.2 to 13.5 vol %. The porosity was then used to calculate the initial surface area of the disk. Disks were soaked in 0.1 M HCl solution for 30 to 35 minutes. After that, the disks were thoroughly rinsed with deionized water before being mounted to the rotating disk apparatus.

### Emulsified GLDA and HEDTA Preparation

Preparation of the emulsified GLDA or HEDTA was accomplished in a systematic way, to warrant the reproducibility of the results. GLDA or HEDTA solutions of 20 wt % were made as above, by adding deionized water. The cationic emulsifier was added to the diesel, and mixed using a mixer. Then, the 20 wt % GLDA or HEDTA solution was added to the diesel solution and mixing was performed at a constant speed (600 rpm). The final volume fraction of the emulsion was 70% GLDA or HEDTA solution in 30 vol % diesel solution. The electric conductivity of the final emulsified GLDA or HEDTA was measured in a conductivity meter (Marion L, model EP-10) to confirm the quality of the final emulsion. For an electric conductivity of nearly 0, a well-emulsified GLDA or HEDTA was prepared, otherwise, the mixing time at the maximum possible speed was increased to ensure the creation of a good emulsion.

### Equipment

Reaction rate experiments were performed using a rotating disk apparatus. All acid-wetted surfaces were manufactured from Hastelloy-C. The rotating disk apparatus consists of an acid reservoir, reaction vessel, gas booster system, heaters, associated pressure regulators, valves, temperature and pressure sensors, and displays. The reactor and reservoir vessels were heated up to the desired temperature. After stabilizing the temperature in both vessels, the regular or emulsified GLDA solution was transferred from the reservoir to the reactor, and the reactor pressure was adjusted to 1,100 psi (75.8 bar), in order to keep the CO₂ in solution. Then, the disk rotation was started, and during the experiment small samples (about 3 cm³) were collected periodically from the reaction vessel through the sampling valve. The samples, containing emulsions, were left to separate, and after separation a small sample of the aqueous phase was drawn using a syringe and diluted, in order to measure the calcium concentration using the Inductively Coupled Plasma (Optical Emission Spectrometer, Optima 7000DV).

The coreflood setup was constructed to simulate a matrix stimulation treatment. A back pressure of 1,100 psi (75.8 bar) was applied to keep CO₂ in solution. Pressure transducers were connected to a computer to monitor and record the pressure drop across the core during the experiments. A Teledyne ISCO D500 precision syringe pump, which has a maximum allowable working pressure of 2,000 psi (138 bar), was used to inject the regular GLDA, emulsified GLDA or emulsified HEDTA into the core.

### Example 2

### Reaction Rate with Limestone Comparing a GLDA Solution with Emulsified GLDA

The dissolution rate of calcite in emulsified GLDA was measured at temperatures of 250 and 300° F. (121 and 149° C.) and at a disk rotational speed of 1,000 rpm. Samples were withdrawn from the reactor every 2 minutes for 20 minutes at a temperature of 250° F. (121° C.), and every 1 minute for 10 minutes at a temperature of 300° F. (149° C.). The calcium concentration in each sample was measured using the ICP (Inductively Coupled Plasma), the calcium concentration was plotted as a function of the reaction time, and the dissolution rate was obtained.

The dissolution rates of calcite in emulsified GLDA at temperatures of 250 and 300° F. (121 and 149° C.) and a disk rotational speed of 1,000 rpm were found to be 1.13×10⁻⁷ and 2.37×10⁻⁷ gmol/cm²·s, respectively. The dissolution rates of calcite in a 20 wt % GLDA aqueous solution (regular GLDA) at temperatures of 250 and 300° F. (121 and 149° C.) and a disk rotational speed of 1,000 rpm are 4.83×10⁻⁶ and 7.67×10⁻⁶ gmol/cm²·s, respectively. From these results it is obvious that with emulsified GLDA dissolution rates of one order of magnitude less than that of regular GLDA solutions were achieved.

### Example 3

### Coreflood Experiments with Limestone Comparing a GLDA Solution with Emulsified GLDA

Coreflood experiments were performed comparing the emulsified GLDA systems formulated using 1.0 vol % emulsifier with a 20 wt % GLDA aqueous solution (regular GLDA) at pH=3.8. Two coreflood experiments were performed at a temperature of 350° F. (177° C.) and an injection rate of 1.0 cm³/min. In each experiment 2 pore volumes of the compositions were injected and left to soak inside the limestone core for 3 hours to enable optimal reaction. The results are shown in Table 2 and show that emulsified GLDA improved the permeability of the limestone by a factor of 3, whereas the regular GLDA improved the permeability only by a factor of 1.73.

TABLE 2
Comparison between regular GLDA and emulsified GLDA
in coreflood experiments with limestone cores

| Liquid | Kᵢₙᵢₜᵢₐₗ (mD) | K_{final} (mD) | K_{final}/Kᵢₙᵢₜᵢₐₗ |
|---|---|---|---|
| Regular GLDA | 6.7 | 11.7 | 1.73 |
| Emulsified GLDA | 4.8 | 14.5 | 3.02 |

### Example 4

### Coreflood Experiments with Limestone Comparing Emulsified GLDA with Emulsified HEDTA

Coreflood experiments were performed comparing the emulsified GLDA system with the emulsified HEDTA system, wherein both systems were formulated using 1.0 vol % emulsifier. Two coreflood experiments were performed at a temperature of 350° F. (177° C.) and an injection rate of 1.0 cm³/min. In each experiment 2 pore volumes of the compositions were injected and left to soak inside the limestone core for 3 hours to enable optimal reaction. The results are shown in Table 3 and show that emulsified GLDA improved the permeability of the limestone by a factor of 3.02, whereas emulsified HEDTA improved the permeability only by a factor 1.37.

TABLE 3
Comparison between emulsified GLDA and emulsified
HEDTA in coreflood experiments with limestone cores

| Liquid | Kᵢₙᵢₜᵢₐₗ (mD) | K_{final} (mD) | K_{final}/Kᵢₙᵢₜᵢₐₗ |
|---|---|---|---|
| Emulsified GLDA | 4.8 | 14.5 | 3.02 |
| Emulsified HEDTA | 5.2 | 7.1 | 1.37 |

1. Composition containing a dispersed phase emulsified in a continuous phase, wherein at least 5 wt % on total weight of the dispersed phase of the composition is a chelating agent selected from the group of glutamic acid N,N-diacetic acid or a salt thereof (GLDA), aspartic acid N,N-diacetic acid or a salt thereof (ASDA), and methylglycine N,N-diacetic acid or a salt thereof (MGDA).

2. Composition of claim 1 containing in addition an emulsifying agent in an amount of 0.01 to 10 vol % on total volume of the composition.

3. Composition of claim 1, wherein the dispersed phase of the composition contains between 5 and 30 wt % of GLDA, ASDA, and/or MGDA on the basis of the total weight of the dispersed phase.

4. Composition of claim 2, wherein the emulsifying agent is selected from the group of non-ionic, cationic, anionic, amphoteric surfactants, polymeric surfactants and pickering emulsifiers.

5. Composition of claim 4, wherein the emulsifying agent is a cationic emulsifier.

6. Composition of claim 2 containing more than one emulsifying agent.

7. Composition of claim 1 containing at least 10 vol % of the continuous phase on total volume of the composition.

8. Composition of claim 1 wherein the continuous phase contains a liquid chosen from the group of diesel, light crude oil or xylene.

9. Composition of claim 1 wherein the dispersed phase has a pH of between 3 and 6.

10. Composition of claim 1 wherein the composition in addition contains a further additive from the group of foam extenders, crosslinking agents, anti-sludge agents, surfactants, corrosion inhibitors, corrosion inhibitor intensifiers, foaming agents, viscosifiers, wetting agents, diverting agents, oxygen scavengers, carrier fluids, fluid loss additives, friction reducers, stabilizers, rheology modifiers, gelling agents, scale inhibitors, breakers, salts, brines, pH control additives, bactericides/biocides, particulates, crosslinkers, salt substitutes, relative permeability modifiers, sulfide scavengers, fibres, nanoparticles, and consolidating agents.

11. Composition of claim 1 wherein the dispersed phase contains water.

12. (canceled)

13. Process for treating a subterranean formation comprising introducing a composition of claim 1 into the formation.

14. Process of claim 13, wherein the pH of the composition is between 2 and 6.

15. Process of claim 13 that is a matrix-acidizing process or an acid-fracturing process.

16. Process of claim 13 wherein a filter cake formed by a water based drilling mud is at least partially degraded.

17. Process of claim 13 wherein the process is performed at a temperature of between 200 and 400° F.

18. Process of claim 13 wherein the composition is introduced in the formation at 0.1 to 4 barrels/ft of target zone.

19. Process of claim 13 in addition comprising a soaking step.

20. Composition of claim 5, wherein the cationic emulsifier comprises an emulsifier containing quaternary ammonium group-containing components.
